(19) United States
(12) Patent Application Publication
(10) Pub. No.: US 2005/0255005 A1
(43) Pub. Date: Nov. 17, 2005

(54) Stackable pipette tips having increased accuracy

(76) Inventor: Arta Motadel, La Jolla, CA (US)

Correspondence Address: Joseph J. Jochman;ANDRUS, SCEALES, STARKE & SAWALL, LLP, 100 East Wisconsin Avenue, Suite 1100, Milwaukee, WI, 53202-4178, US

(21) Appl. No.: 10/844,966

(22) Filed: May 13, 2004

(51) Int. Cl. B01L 3/02

(52) U.S. Cl. 422/100

(57) ABSTRACT

Stackable pipette tips having increased accuracy are provided through a unique pipette tip comprising a collar, a barrel and an acutely tapered neck transitioning between the collar portion and the barrel portion. The pipette tip of the present invention has a significant reduction of inner volume resulting from the acute taper and several other tapers along the inner surface. This reduction of inner volume provides a tip with greater accuracy, as less air must be displaced in order to aspirate and dispense small aliquots of liquid. The pipette tips of the present invention also are directly stackable in a rack on one another without interaction causing lodging, binding or clinging between the outer surface of the top or stacked tip and the inner surface of the base or bottom tip.

### BACKGROUND OF THE INVENTION

Pipette tips come in a multitude of configurations for use with various different pipetting equipment. As the biotechnological arts advance, it is becoming increasingly important to accurately aspirate and dispense small aliquots of liquid, for example, moving 1 to 3 microliter aliquots from one well plate to another. After such a pipette tip is used to transfer a small aliquot of liquid, it is normally discarded and a new tip is mounted to the pipetting equipment before the process is repeated to minimize cross-contamination. Automated liquid handling equipment is used to move such small aliquots on a large scale. Therefore, it has become advantageous to provide a large number of disposable tips in an orderly fashion, normally as an array in a rack, for use on the automated liquid handling equipment.

In order to repeatedly move such small aliquots of liquid on a large scale, researchers use automated, robotic handling systems. Such automated liquid handling systems comprise pipetting “heads” capable of holding 96, 384 or even 1536 tips. The liquid handling systems can simultaneously transfer small aliquots of liquid from a source plate containing 96, 384, or 1536 wells to a destination plate containing 96, 384 or 1536 wells. Additionally, such liquid handling systems are often adaptable so that 96 tip heads can transfer liquid to a 1536 plate using certain formatting and indexing capabilities.

Automated liquid handling systems of the type described above typically use disposable pipette tips loaded or arrayed in a rack. Such pipette tips may include a barrier member or filter to further minimize cross-contamination, although non-filtered tips are more commonly used in low volume applications. Pipette tips traditionally used with automated liquid handling systems are relatively long and have a collar portion for mounting to a head of the liquid handling equipment. Traditional tips also have a roughly tapered barrel portion. This design requires that a relatively large volume of air be displaced in order to aspirate and dispense liquids. Significantly, as more air is displaced, the accuracy of the pipette tip decreases, especially at low volumes such as 1 to 3 microliter aliquots.

Since automated liquid handling systems generally use an array of disposable pipette tips, before being discarded, various types of pipette tip packaging and loading systems are prevalent. Although pipette tips can be sold loose and placed into racks on site, it is common to sell pipette tips in plastic tip holders that are then loaded as an array into the rack from which the tips are mounted onto the head of the automated liquid handling apparatus.

PCT Application No. WO 01/10556A1 demonstrates a pipette tip kit for packaging a plurality of nested conical tips including a support surface and lateral contact with all the tips. The tips may be taken directly from the kit into a pipette or may be transferred from the tip kit into a rack by removing the support surface from a row of the tips. The kit is particularly used for storage and transport of tips prior to placing such tips into a rack.

As illustrated in the prior art, in order to conserve packaging and storage space, it is advantageous to stack layers of pipette tips in a nesting arrangement. However, directly nested tips tend to bind or cling to one another when loaded into racks. Therefore, some known prior art tip loading systems require an intermediate tip support plate in between the layers of racked tips to prevent the racked tips from nesting too closely. The intermediate structure provides appropriate spacing between stacked tips such that close nesting does not occur and the tips may be stacked without causing functional or static attraction that can lead to problems when loading the tips onto heads of an automated liquid handling system.

Those skilled in the art will appreciate that the use of such intermediate structures creates extra waste, increases the cost of manufacturing and adds weight to the product, which increases the cost of shipping.

### SUMMARY OF THE INVENTION

The present invention is directed to a pipette tip having increased accuracy and capable of being directly stacked into a rack without nesting too closely and without an intermediate support. While the pipette tip achieves the greater accuracy whether or not a filter is in place, the direct stacking of the pipette tips is achieved in filterless tips.

The pipette tip of the present invention is particularly suitable for aspirating and dispensing small aliquots of a liquid. The pipette tip comprises a collar defining an inside surface that is adapted to receive a pipette mounting shaft, a neck and a barrel, each also having an inside surface, the neck connecting the collar to the barrel. The inside surfaces of the collar, neck and barrel define an internal volume aligned along a central longitudinal axis of the tip. The inside diameter of the tip is reduced by at least 50% as the neck extends from the collar to the barrel and the inner diameter of the neck is reduced at a rate of between 40° to 60° as measured from the central longitudinal axis.

This construction substantially reduces the dead air space in the pipette tip. The tip preferably has a conventional generally conical longitudinal cross section.

The collar preferably includes a tapered guide surface to aid in directing the insertion of the pipette mounting shaft. Preferably, the inner diameter of the neck is reduced at a rate of between 45° and 50°.

The barrel of the tip preferably comprises a top barrel portion and a terminating barrel portion, and a step defining a transition between the barrel portions. The terminating barrel portion defines a volume for handling the small aliquots of liquid. Preferably, the terminating barrel portion defines a volume adapted to accurately pipette 1 to 3 microliter aliquots. Further, the small volume terminating barrel portion and the reduced dead air space in the upper portion of the tip creates a pipetting accuracy of ±½ microliter. The pipette tip may be fitted with a filter member, preferably comprising a filter body press fit into the top barrel portion. The filter body may extend upwardly from the top barrel portion into the neck. The filter body preferably comprises a porous block of hydrophobic material, such as polyethylene, impregnated with a hydrophilic material, such as cellulose.

In a further aspect of the present invention, the pipette tip is made to be stackable and comprises an outer surface, an inner surface, a collar that has an opening and an inside surface adapted to receive a pipette mounting shaft, a neck and a barrel each having an inside surface, the inside surface of the collar, neck and barrel define an internal volume that is aligned along a longitudinal central axis. The neck provides a transition between the collar and the barrel. The outer surface of the collar comprises a top surface that extends circumferentially around the collar opening and at least one shoulder that is positioned longitudinally toward the barrel such that, when stacking a first of said pipette tips on top of a second of said pipette tips, the shoulder on the first pipette tip contacts the top surface of the collar of the second pipette tip to create a positive stop supporting the first pipette tip and suspending its barrel within the internal volume of the second pipette tip. This allows the pipette tips to be directly stacked on one another with the barrel of the first pipette tip contained within the internal volume of the second pipette tip and prevents binding contact between the inner surface of the second pipette tip and the outer surface of the first pipette tip.

Preferably, the top surface and the shoulder comprise flat parallel surfaces that are in abutting contact in the stacking position. The abutting surfaces lie in a plane perpendicular to the longitudinal axis of the tip. In a preferred construction, the tip comprises a plurality of axially extending circumferentially spaced ribs on the outside surface of the collar, the axially opposite ends of the ribs defining respectively the top surface and the shoulder.

In one embodiment, the collar comprises a top collar portion that provides an opening for receipt of the pipette mounting shaft and defined by a wall of maximum collar thickness. A sealing collar portion extends from adjacent the top collar portion and is joined thereto by a taper. The sealing collar portion has an inside diameter less than the inside diameter of the top collar portion and defines a sealing surface for the pipette mounting shaft. The sealing wall portion is preferably defined by a wall having a thickness less than the maximum collar thickness.

### BRIEF DESCRIPTION OF THE DRAWINGS

FIG. 1 is a perspective view of the pipette tips of the present invention stacked in a tray;

FIG. 2 is a perspective view of a pipette tip of the present invention FIG. 3 is an end view of a pipette tip of the present invention;

FIG. 4 is a cross-sectional view of a pipette tip of the present invention taken along line 4-4 of FIG. 3;

FIG. 5 is a cross-sectional view of a pipette tip of the present invention demonstrating the insertion of a mounting shaft into the pipette tip;

FIG. 6 is a cross-sectional view of two pipette tips of the present invention demonstrating the direct stacking of two or more tips without nesting.

FIG. 7 is a cross-sectional view of an embodiment of a pipette tip of the present invention incorporating a filter for reducing contamination.

### DETAILED DESCRIPTION OF THE PREFERRED EMBODIMENTS

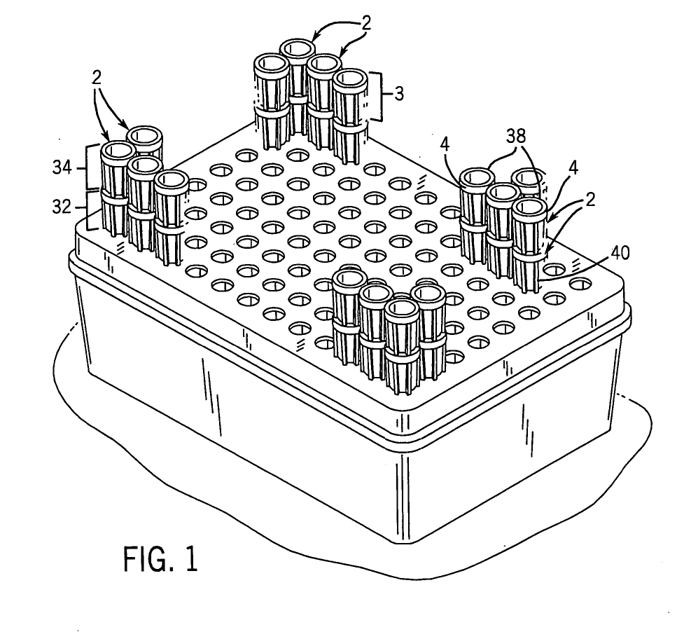

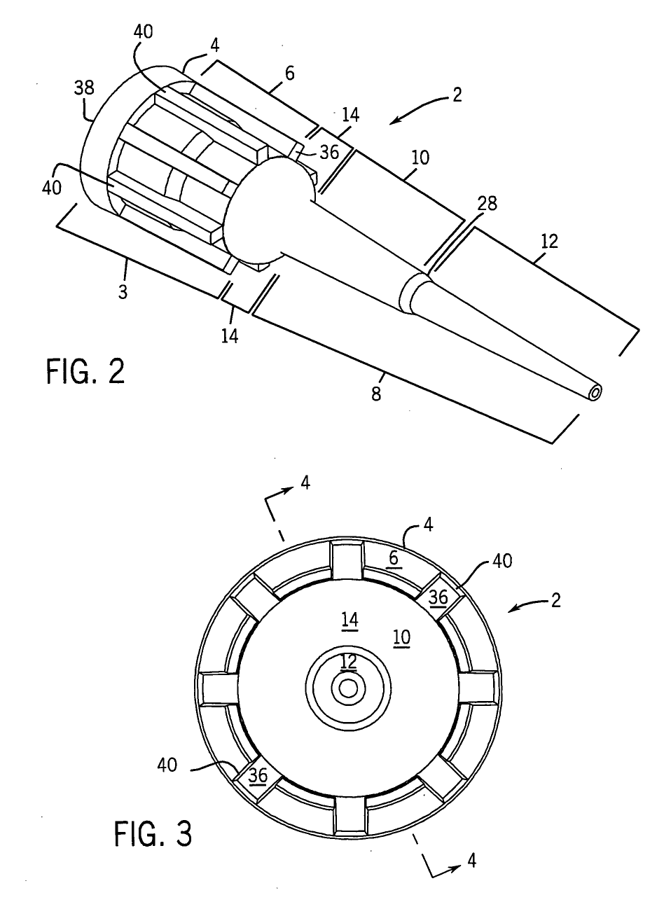

Referring to FIGS. 1-4, a preferred pipette tip 2 is of a generally conical construction and comprises a collar 3. In the preferred embodiment, the collar 3 further comprises a top collar portion 4 and an intermediate collar portion 6. The intermediate collar portion 6 extends axially from the top collar potion 4. A barrel 8 is axially spaced from collar 3. In the preferred embodiment, the barrel 8 comprises a top barrel portion 10 and a terminating barrel portion 12. The terminating barrel portion 12 extends axially from the top barrel portion 10, and contacts a liquid.

An acutely tapered neck 14 provides a transition between the collar 3 and the barrel 8. In the preferred embodiment, the acutely tapered neck 14 is positioned between the intermediate collar portion 6 and the top barrel portion 10. The acutely tapered neck 14 has an angular component or slope, as measured from the longitudinal axis of the top, between 40° and 60°, and preferably between 45° and 50°.

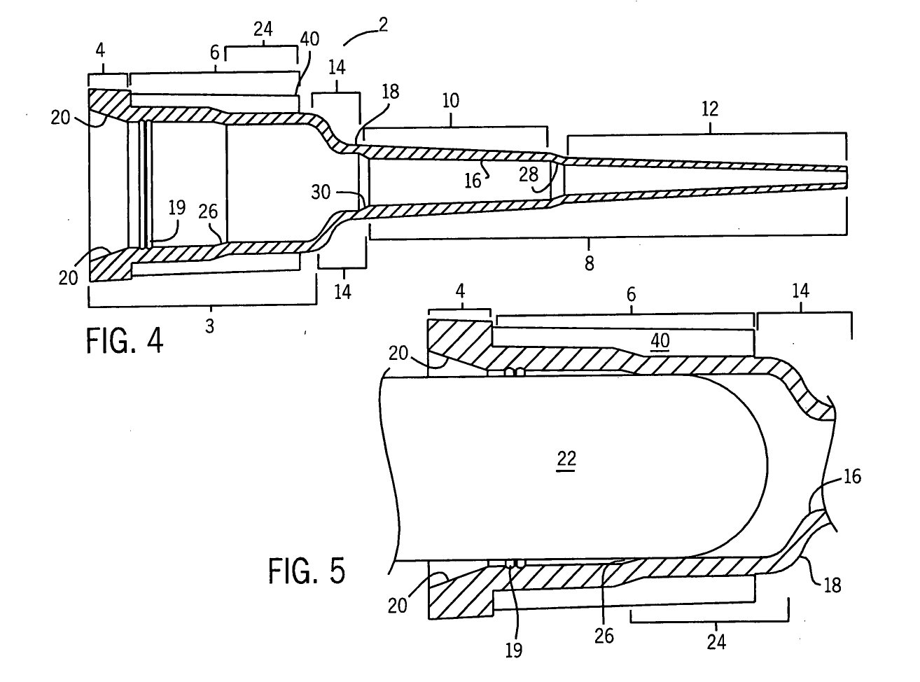

Referring now to FIGS. 4-6, the pipette tip of the present invention has an inner surface 16 and an outer surface 18. The inner surface 16 includes pull rings 19 used to remove pipette tips from a mold during manufacturing. The diameter of the inner surface is progressively reduced from the collar 3 to the tip of the barrel 8 through a series of tapers. In the preferred embodiment, the top collar portion 4 includes a tapered guide surface 20 to direct a mounting shaft 22 of a pipetting apparatus into proper position in the pipette tip 2. Alternatively, the pipette tip of the present invention may be constructed without a tapered guide surface 20; however, a tapered guide surface 20 is advantageous, particularly when the pipette tips 2 are utilized in conjunction with an automated liquid handling apparatus such as the Biomek® Laboratory Workstation manufactured by Beckman Coulter, Inc. of Fullerton, Calif., USA.

In the preferred embodiment, the tapered guide surface 20 transitions into the intermediate collar portion 6. The intermediate collar portion 6 includes a sealing collar portion 24. The sealing collar portion 24 is defined by a sealing taper 26 located on the inner surface 16 of the intermediate collar portion 6. The sealing collar portion 24 operates to engage the mounting shaft 22 to create an operative seal between the pipette tip 2 and the mounting shaft 22. The operative seal allows for the air displacement operation of pipetting equipment to operate effectively and efficiently. As is best seen in FIGS. 4 and 5, the sealing collar portion 24 is of a reduced wall thickness as compared to the wall thickness of that portion of the collar between a sealing taper 26 and the top collar portion 4. This reduced wall thickness provides a relative flexibility in the collar that enhances the seal with the pipetter shaft 22 and also permits easy withdrawal thereof. Further, the sealing taper 26 places the inside surface of the thicker upper portion of the collar out of contact by the pipetter mounting shaft 22.

In the preferred embodiment, as demonstrated in FIG. 4, the acutely tapered neck 14 transitions between the sealing collar portion 24 of the intermediate collar portion 6 and the top barrel portion 10. The acutely tapered neck 14 reduces the diameter of the inner surface 16 by at least 45%, and preferably by 52%.

A barrel step 28 is present in the preferred embodiment on the inner surface 16 at the transition between the top barrel portion 10 and the terminating barrel portion 12. In the preferred embodiment, the terminating barrel portion 12 has a reduced cross section as compared to the top barrel portion 10. Thus, the substantially reduced cross section of the top barrel portion 10 below the neck 14 minimizes the dead air space and the further cross sectional reduction of the termination barrel portion permits the aspiration and dispensing of an aliquot of liquid as small as 1 microliter and with precise volume control. It is contemplated that the terminating barrel portion of the preferred embodiment will be used for pipetting 1 to 3 microliter aliquots with an accuracy of plus or minus ½ of a microliter. The top barrel portion further includes a transition taper 30 on the inner surface 16. The transition taper 30 is used to maintain optimal air volume for displacement accuracy.

The acutely tapered neck 14, the barrel step 28 and the transition taper 30 progressively reduce the diameter of the inner surface from the top collar portion 4 to the terminating barrel portion 12. This progressive reduction in diameter reduces the amount of air space within the tip above the liquid sample. Accordingly, when a pipetting device engages the tip to pipette a liquid, less air must be displaced to aspirate and dispense a liquid.

Minimizing the dead air space provides greater accuracy in pipetting, with the preferred embodiment of the present invention capable of pipetting small aliquots of the liquid, e.g., 1 to 3 microliters, with an accuracy of plus or minus ½ microliter. The reduction in dead space is mostly achieved through the neck 14, but the barrel step 28 and the transition taper 30 also aid in minimizing the dead space and thus optimize the accuracy of the pipette tip of the present invention. The terminating barrel portion 12 of the present invention, in one embodiment, is dimensioned to hold a 1 to 3 microliter aliquot of a liquid. The terminating barrel portion has a maximum inside diameter on its upper end of 0.042 inch (about 1 mm), a minimum inside diameter at the tip of 0.016 inch (about 0.4 mm) and a length of 0.405 inch (about 10 mm). However, the entire barrel 8, including the top barrel portion 10 and the terminating barrel portion 12, has a volume capacity of 10 microliters. The pipette tip of the present invention thus has a useful volume range of up to 10 microliters. Obviously, larger or small pipette tips made in accordance with the teachings of the present invention may also be utilized.

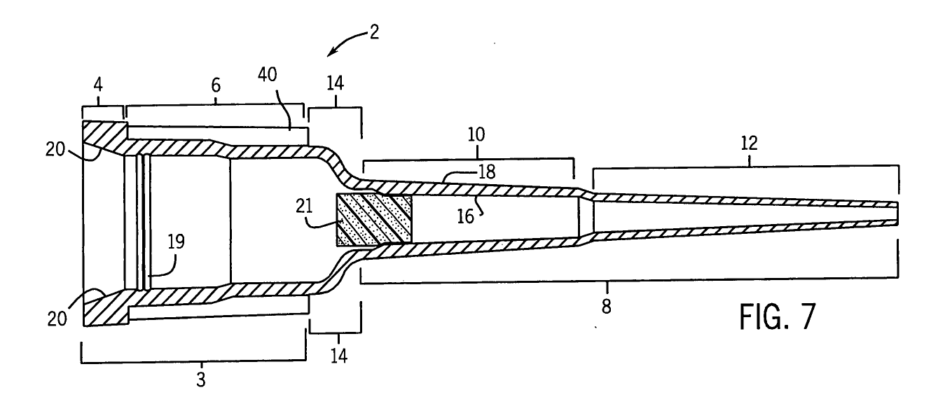

Referring now to FIG. 7, the pipette tip 2 of the present invention may further comprise a filter member 21. The filter member 21 may be located at a number of positions in the pipette tip, for example, in the terminating barrel portion 12, the top barrel portion 10, the acutely tapered neck 14, or the collar 3. Preferably, the filter member 21 is located in the top barrel portion 10 with a portion protruding into the acutely tapered neck 14. The filter member 21 is preferably force or interference fitted securely into the top barrel portion 10 so that it is securely held and frictionally sealed in the inner surface 16, although not physically attached to the inner surface 16 by any adhesive or other extraneous material. The filter member 21 operates to prevent or inhibit the passage of gas or liquid when contacted with an aqueous liquid or vapor and helps prevent sample overflow in the pipette tips of the present invention. In preventing sample overflow, the filter member 21 helps reduce the risk of cross contamination during experimentation. One common type of filter which is readily adaptable for use in the pipette tip 2 of the present invention is a microporous polyethylene body that is inherently hydrophobic in which the pores are impregnated with an inherently hydrophilic material, such as a cellulose material. It will be understood that the optional use of filters in pipette tips of the present invention will preclude the stackability feature described below.

Referring now to FIGS. 1, 2 and 6, the pipette tip 2 of the present invention is designed such that two or more of the pipette tips 2 may be directly stacked on one another without nesting contact causing lodging, binding or clinging between the inner surface 16 of a base or bottom pipette tip 32 and the outer surface 18 of a stacked or top pipette tip 34. It will be understood by one of ordinary skill in the art that any one individual pipette tip 2 may operate as the base or bottom pipette tip 32 and any other pipette tip 2 may operate as the stacked or top pipette tip 34.

The pipette tip 2 of the present invention allows for direct stacking of two or more pipette tips 2 without nesting contact causing lodging, binding or clinging between the tips. Significantly, no intermediate plate or structure is necessary to prevent such contact. Thus, two or more of the pipette tips 2 of the present invention may be directly stacked on one another without nesting contact causing lodging, binding or clinging between the outer surface of one stacked or top tip and the inner surface of another base or bottom tip.

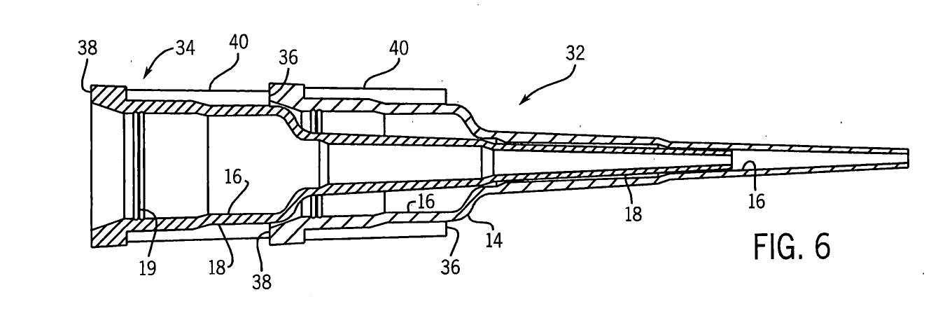

Referring to FIGS. 1, 2 and 6, two or more pipette tips 2 are directly stacked. The collar 3 of the pipette tip includes a bottom surface defining a shoulder 36 and a top surface 38. The bottom shoulder 36 of the top pipette tip 34 is disposed in contact with the top surface 38 of the bottom pipette tip 32. In this manner, the shoulder 36 operates as a positive stop surface, reducing interaction between stacked tips to facilitate the direct stacking illustrated in FIGS. 1 and 6. The surface of the shoulder 36 and top surface 38 of the tip are flat and parallel to one another to provide full abutting surface contact when stacked. Further, the planes of the abutting surfaces 36 and 38 are preferably perpendicular to the longitudinal axis of the tip. In the construction shown in the drawings, the outer surface of the collar 3 is provided with a plurality of axially extending, and circumferentially spaced ribs, the upper ends of which blend into the cylindrical top collar portion 4 and the lower ends of which define a plurality of co-planar shoulders 36. In the embodiment shown, the top surface comprises a continuous annular surface defining the upper face of the top collar portion 4.

Further, the barrel 8 of the pipette tip member 2 is comparatively short when compared to other pipette tips known in the art. The outer surface 18 of the barrel portion 8 of the top pipette tip 34 stacked within the bottom tip 32 is positioned with a small clearance from the inner surface 16 of the barrel 8 of the bottom tip 32 and does not lodge, bind or cling to the inner surface 16 of the bottom tip 32. The absence of any lodging, binding or clinging is further realized through the acutely tapered neck 14 and the collar 3 which allow the barrel 8 of two or more stacked tips to be arranged with minimal interaction. Also, the preferred embodiment utilizes an anti-static thermoplastic resin to further reduce interaction between directly stacked tips. A preferred anti-static resin is CESA-STAT PEATEC 17690 available from Winchester-Masterbatches of Winchester, Va. Those skilled in the art will recognize that other anti-static resins are available and compatible with the present invention.

In a preferred embodiment of the present invention, the collar 3 includes a plurality of axially extending support ribs 40. The support ribs 40 are concentrically arranged on the collar 3 about the central axis of the pipette tip, such that the support ribs are radially spaced from the barrel and the acutely tapered neck. The support ribs 40 may also extend axially from the top collar portion 4 in one embodiment. Either the top collar portion 4, the top surface of the support ribs 40, or both may define the top surface 38 of the collar 3.

It will be well recognized by one of ordinary skill in the art that the collar 3 may have many different configurations and yet achieve the desirable stackable characteristics of the present invention. Such configurations are deemed to be well within the scope of this patent. However, the preferred embodiment of the present invention that incorporates the support ribs 40 provides other advantages, namely, allowing the pipette tip to be narrow and short, which in turn, allows for the pipette tip 2 to have a minimum volume of dead space to achieve a greater accuracy. Further, the support ribs 40 allow the weight of the tip to be centered around the collar 3. By centering the weight of the tip about the collar 3, the tips readily maintain a central orientation when stacked. This central orientation allows for the tips to be readily used in conjunction with an automated liquid handling apparatus such as the Biomek® FX Laboratory Workstation by Beckman Coulter, or other comparable systems.

It will also be well recognized by one of ordinary skill in the art that the stackable pipette tips of the present invention may be stacked for storage in many different manners. The stackable pipette tips of the present invention may be directly stacked upon one another without nesting contact in conventional racks without intermediate support structures as previously described. Further, the stackable pipette tips of the present invention may be spring loaded into a dispenser such that once a first tip is removed, the subsequent tip springs up immediately. Such an arrangement may be useful in automated systems. The stackable pipette tips of the present invention may also be used in many other conventional packaging methods as are well known in the art. Regardless of the type of packaging used, the stackable pipette tips of the present invention are capable of being directly stacked upon one another without nesting contact, causing lodging, binding or clinging between the tips. Thus, two or more of the stackable pipette tips of the present invention may be stacked directly on one another in various types of packaging arrangements without nesting contact between the tips causing lodging, binding or clinging between the outer surface of one stacked or top tip and the inner surface of another base or bottom tip.

It should be apparent to those skilled in the art that the pipette tip of the present invention as described herein contains several features, and that variations of the preferred embodiment disclosed herein may be made which embody only some of the features disclosed herein. For example, it may be desirable to utilize the construction of the pipette member 2 to accurately pipette larger volumes of liquid. Further, it may be desirable to use the construction of the present invention to construct stackable pipette tips having almost any volume capacity. Additionally, the collar portion may have a multitude of configurations that achieve the desired stackability without nesting. For example, the collar portion may be a solid radially spaced portion sufficiently spaced from the acutely tapered section to allow stackability or the lower collar may be an axially spaced ring. Also, various configurations are contemplated to achieve a centering of the weight about the collar portion. For example, a plurality of axially spaced rings, a matrix or lattice design or a solid radially spaced portion may effectively achieve this characteristic.

Various other combinations and modifications or alternatives may also be apparent to those skilled in the art. Such various alternatives and other embodiments are contemplated as being within the scope of the following claims, which particularly point out and distinctly claim the subject matter regarded as the invention.

1. A pipette tip for accurately aspirating and dispensing small aliquots of liquid comprising:
a collar having an inside surface adapted to receive a pipette mounting shaft;
a neck and a barrel each also having an inside surface, the neck containing the collar to the barrel, and the inside surfaces of the collar, neck and barrel defining an internal volume aligned along a central longitudinal axis;
wherein the inside diameter of the pipette tip is reduced by at least fifty (50%) percent as the neck extends from the collar to the barrel and the inner diameter of the neck is reduced at a rate of between 40 to 60 degrees as measured from the central longitudinal axis, thereby reducing dead air space in the pipette tip.

2. The pipette tip of claim 1, wherein the tip has a generally conical longitudinal cross-section.

3. The pipette tip of claim 1, wherein the collar includes a tapered guide surface to direct a mounting shaft.

4. The pipette tip of claim 1, wherein the collar portion includes an inner sealing portion to engage a mounting shaft to create an operative seal between the sealing portion of the collar and the mounting shaft.

5. The pipette tip of claim 1, wherein the inner diameter of the neck is reduced at a rate of between 45° and 50°.

6. The pipette tip of claim 2, wherein the barrel comprises a top barrel portion and a terminating barrel portion and a step defining a transition between the top barrel portion and the terminating barrel portion.

7. The pipette tip of claim 6 wherein the terminating barrel portion defines a volume for handling the small aliquots of liquid.

8. The pipette tip of claim 7, wherein the terminating barrel portion defines a volume adapted to accurately pipette 1 to 3 microliter aliquots of a liquid.

9. The pipette tip of claim 8, wherein the small volume terminating barrel portion and the reduced dead air space creates an accuracy of + or −½ microliter.

10. The pipette tip of claim 1, wherein the pipette tip further includes a filter member.

11. The pipette tip of claim 10 wherein the filter member comprises a filter body press fit in the top barrel portion.

12. The pipette tip as set forth in claim 11 wherein the filter body extends upwardly from the top barrel portion into the neck.

13. The pipette tip as set forth in claim 11 wherein the filter body comprises a porous block of hydrophobic material impregnated with a hydrophilic material.

14. The pipette tip as set forth in claim 13 wherein the filter body comprises a cellulose-impregnated polyethylene block.

15. A stackable pipette tip comprising:
an outer surface;
an inner surface;
a collar having an opening and an inside surface adapted to receive a pipette mounting shaft;
a neck and a barrel each also having an inside surface, the inside surface of the collar, neck and barrel defining an internal volume aligned along a longitudinal central axis;
the neck transitioning between the collar and the barrel;
wherein the outer surface of the collar comprises a top surface extending circumferentially around the collar opening and at least one shoulder positioned longitudinally towards the barrel such that, when stacking a first of said pipette tips on top of a second of said pipette tips, the shoulder of the first pipette tip contacts the top surface of the collar of the second pipette tip to create a positive stop supporting the first pipette tip and suspending its barrel within the internal volume of the second pipette tip, thereby allowing the pipette tips to be directly stacked on one another with the barrel of the first pipette tip contained within the internal volume of the second pipette tip and preventing binding contact between the inner surface of the second pipette tip and the outer surface of the first pipette tip.

16. The pipette tip of claim 15 wherein the top surface and the shoulder comprise flat parallel surfaces in abutting contact in the stacking position.

17. The pipette tip as set forth in claim 16 wherein the abutting surfaces lie in a plane perpendicular to the longitudinal axis of the tip.

18. The pipette tip as set forth in claim 15 comprising a plurality of axially extending circumferentially spaced ribs on the outside surface of the collar, the axially opposite ends of the ribs defining said top surface and said shoulder.

19. The pipette tip as set forth in claim 1 wherein the collar comprises a top collar portion providing an opening for receipt of the pipette mounting shaft and defined by a wall of maximum collar thickness, a sealing collar portion adjacent the top collar portion and joined thereto by a taper, the sealing collar portion having an inside diameter less than the inside diameter of the top collar portion and defining a sealing surface for the mounting shaft.

20. The pipette tip as set forth in claim 19 wherein the sealing wall portion is defined by a wall having a thickness less than said maximum collar thickness.
